(19) United States
(12) Patent Application Publication
(10) Pub. No.: US 2025/0168676 A1
(43) Pub. Date: May 22, 2025

(54) SYSTEMS AND METHODS FOR DERIVING BASELINE RADIO FREQUENCY MEASUREMENTS OF COVERAGE AREAS

(71) Applicant: Verizon Patent and Licensing Inc., Basking Ridge, NJ (US)

(72) Inventors: Seng GAN, Ashburn, VA (US); Andrew F. PATKA, Holliston, MA (US); Nitheesh TEJAPRAKASH SHETTY, Tampa, FL (US); Anand BHATIA, Flower Mound, TX (US); Soumava DUTTA, Belle Mead, NJ (US); Ajaykumar KALLA, Frisco, TX (US); Anil Kumar VASHISTHA, East Brunswick, NJ (US); Christopher T. DEMIR, Ranson, WV (US); Saibaba ATTELLI, Chalfont, PA (US); Ronald CARLONI, Bloomfield, NJ (US)

(73) Assignee: Verizon Patent and Licensing Inc., Basking Ridge, NJ (US)

(21) Appl. No.: 18/514,721

(22) Filed: Nov. 20, 2023

(51) Int. Cl. H04W 24/10; H04B 17/318; H04B 17/336

(52) U.S. Cl. CPC H04W 24/10; H04B 17/328; H04B 17/336

(57) ABSTRACT

In some implementations, a server may receive a plurality of signal measurements associated with a coverage area, wherein the plurality of signal measurements are collected over a measurement period by a device within the coverage area while the device is associated with a fixed location. The server may identify a signal measurement from the plurality of signal measurements, wherein the signal measurement represents a baseline radio frequency (RF) environment for the coverage area without a threshold amount of interference or transient changes in the coverage area. The server may provide an output based on the baseline RF environment.

### BACKGROUND

Wireless communication systems are widely deployed to provide various telecommunication services such as telephony, video, data, messaging, and broadcasts. A wireless network may include one or more network nodes that support communication for wireless communication devices, such as a user equipment (UE).

### BRIEF DESCRIPTION OF THE DRAWINGS

FIG. 1 is a diagram of an example associated with a coverage area.

FIG. 2 is a diagram of an example associated with deriving baseline radio frequency (RF) measurements of coverage areas.

FIG. 3 is a diagram of an example associated with an fixed wireless access (FWA) RF baseline algorithm.

FIG. 4 is a diagram of an example associated with a coverage area RF baseline (no grouping) algorithm.

FIG. 5 is a diagram of an example associated with an FWA device group by best base station algorithm.

FIG. 6 is a diagram of an example associated with an FWA device group by connected base station algorithm.

FIG. 7 is a diagram of an example associated with interference.

FIG. 8 is a diagram of an example associated with transmit power.

FIG. 9 is a diagram of an example associated with an FWA as RF detector algorithm.

FIG. 10 is a diagram of an example environment in which systems and/or methods described herein may be implemented.

FIG. 11 is a diagram of example components of one or more devices of FIG. 10.

FIG. 12 is a flowchart of an example process associated with deriving baseline RF measurements of coverage areas.

### DETAILED DESCRIPTION OF EXAMPLE EMBODIMENTS

The following detailed description of example implementations refers to the accompanying drawings. The same reference numbers in different drawings may identify the same or similar elements.

In a wireless network, changes may occur to a radio frequency (RF) environment within a coverage area. The changes may be associated with different frequency bands. The changes may affect an experience of user equipments (UEs) in the coverage area. For example, the changes may reduce a bit rate and/or increase latency for the UEs in the coverage area. However, in some cases, determining times at which the changes occur and/or possible sources of the changes (e.g., a location of a possible source of change) may be difficult. Without such information, remediation may be difficult, which may result in the experience of the UEs in the coverage area not improving.

In some implementations, a measurement device, such as a fixed wireless access (FWA) measurement device may be deployed in a coverage area. The measurement device may perform a continuous wireless survey to collect measurements within the coverage area. The measurement device may not move when performing the continuous wireless survey/measurements within the coverage area. The measurement device may continuously report measurements of a base station's test signal. For example, the base station may transmit the test signal to the measurement device every few milliseconds, and the measurement device may report signal strength measurements to the base station every few seconds. Over a relatively long period of time (e.g., one week), signal strength measurements from the base station may be documented. The signal strength measurements may include reference signal received power (RSRP) measurements, reference signal received quality (RSRQ) measurements, channel quality indicator (CQI) measurements, and/or signal-to-interference-plus-noise ratio (SINR) measurements. At some times, signal strength measurements may be relatively low, which may be due to interference (or blockage) in a wireless network. The interference may be from other UEs moving within the coverage area. The interference may be from non-moving objects or moving objects, such as buildings or trucks, respectively, within the coverage area. At other times, when there is no (or minimal) interference from other UEs or no transient changes in the environment, the signal strength measurements from the base station may be relatively good. Such times may be referred to as “quiet time” due to the lack of interference from other UEs and the lack of temporary disturbance.

In some implementations, the best signal strength measurement(s) collected by the measurement device over a relatively long time period may indicate there is a permanent part of the RF environment measured by the measurement device. The best signal strength measurements may be inferred as being signal strength measurements that are not affected by the interference in the wireless network, and hence, the best signal strength measurements may indicate a fundamental RF environment of the coverage area. When multiple measurement devices are in the coverage area, sufficient measurement data may be available to document the permanent part of the RF environment. By collecting the signal strength measurements over the relatively long period of time, the permanent part of the RF environment may be isolated from temporary changes to the RF environment. As a result, a baseline characterization associated with the RF environment may be obtained, where the baseline characterization may indicate a fundamental RF environment of the coverage area. Based on the baseline characterization, changes to the RF environment may be detected and/or the location of the possible source of the changes may be detected, which may allow a network to perform remediation to improve experience of UEs in the coverage area.

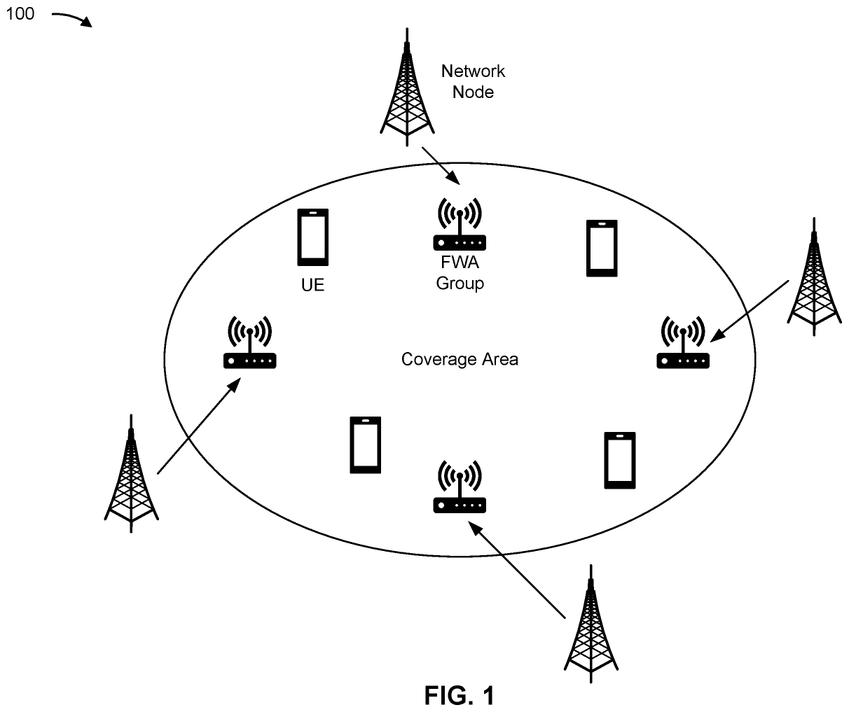

In some implementations, the measurement device, such as the FWA measurement device, may be used as an RF detector to collect continuous RF measurements. By utilizing the best signal strength measurement(s) associated with the “quiet time”, impacts associated with UE interference and/or other transient changes may be eliminated, thereby resulting in the baseline characterization (or RF baseline measurement) associated with the RF environment. Changes in the baseline characterization may be compared with each other to detect RF coverage problems. Further, grouping algorithms (e.g., grouping by best base station or grouping by connected base station) may be used for detecting problem source locations and/or for capacity planning. FIG. 1 is a diagram of an example 100 associated with a coverage area.

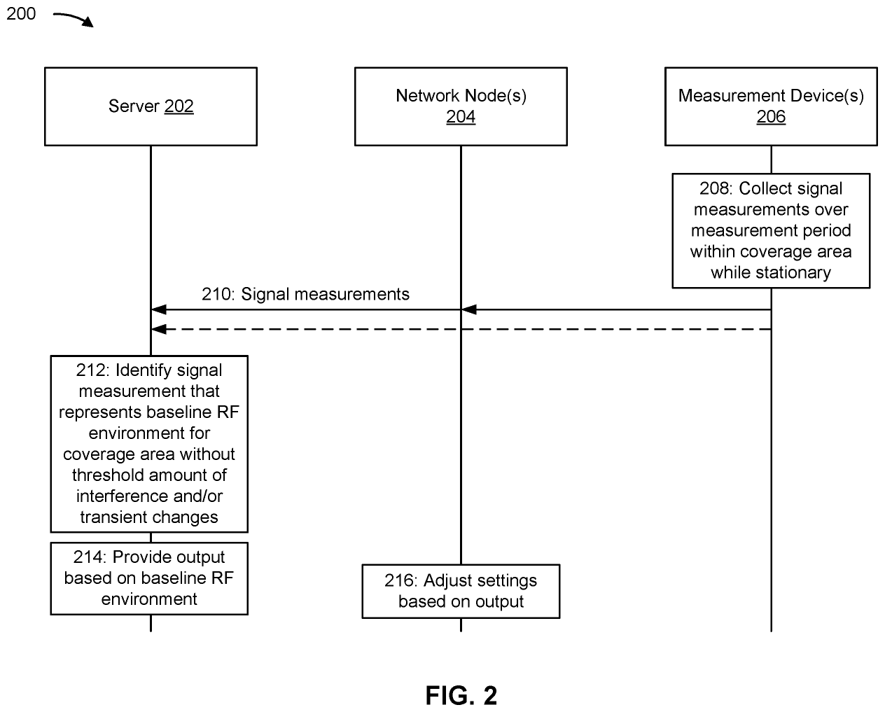

As shown in FIG. 1, a coverage area may include one or more measurement devices (e.g., FWA groups) and one or more UEs. A UE may cause interference for a measurement device. A network node, of a plurality of network nodes, may transmit test signals, which may be received by the measurement device. The measurement device may transmit measurements based on the test signals to the network node, which may relay the measurements to a server (shown in FIG. 2). A permanent part of an RF environment of the coverage area may be based on the measurements collected by the UE, as described in further detail herein.

As indicated above, FIG. 1 is provided as an example. Other examples may differ from what is described with regard to FIG. 1.

FIG. 2 is a diagram of an example 200 associated with deriving baseline RF measurements of coverage areas. As shown in FIG. 2, example 200 includes a server 202, a network node 204 (e.g., a Fourth Generation (4G) evolved node B (eNB) or a Fifth Generation (5G) Next Generation node B (gNB)), and a measurement device 206 (e.g., an FWA device or a UE).

As shown by reference number 208, the measurement device 206 may collect signal measurements over a measurement period within a coverage area while the measurement device 206 is associated with a fixed location. For example, the measurement device 206 may be stationary or not moving when capturing the signal measurements over the measurement period. The plurality of signal measurements may include RSRP measurements, RSRQ measurements, CQI measurements, and/or SINR measurements. The measurement period may be an extended period of time, such as one week or longer, during which the device may be stationary.

As shown by reference number 210, the measurement device 206 may transmit the measurements to the network node 204. The network node 204 may relay the measurements to the server 202. Alternatively, the measurement device 206 may transmit the measurements directly to the server 202. In other words, the server 202 may collect measurement directly from the measurement device 206.

As shown by reference number 212, the server 202 may identify a signal measurement from the plurality of signal measurements, such as a best measurement from the plurality of measurements. The best signal measurement may represent a baseline RF environment for the coverage area without the presence of a threshold amount of interference and/or transient changes in the coverage area. The best signal measurement may be a highest signal measurement among the plurality of signal measurements, where the best signal measurement may correspond to best network conditions for the measurement device 206. The best signal measurement may characterize a fundamental RF environment of the coverage area, and may represent an RF environment that is not affected or minimally affected by interference from UEs in the coverage area and/or transient changes in the coverage area. The best signal measurement may correspond to a time during the measurement period at which the device is not subjected to interference from the UEs or temporary disturbance, and such time may be referred to as “quiet time”.

As shown by reference number 214, the server 202 may provide an output based on the baseline RF environment. For example, the output may be associated with an RF safety margin for adding additional UEs to the coverage area and/or a number of UEs that are able to be added to the coverage area based on an addition or deletion of UEs of historical periods. The output may be an indication of whether measurements have changed from a previous measurement period. The output may be an indication of whether a number of connected UEs have changed from the previous measurement period. The output may be associated with inferred timing and source locations of changes in the coverage area. The output may be associated with capacity planning.

As shown by reference number 216, the network node 204 may adjust one or more settings or network configurations based on the output. For example, the network node 204 may adjust the one or more settings or network configurations to handle an increased number of UEs in the coverage area.

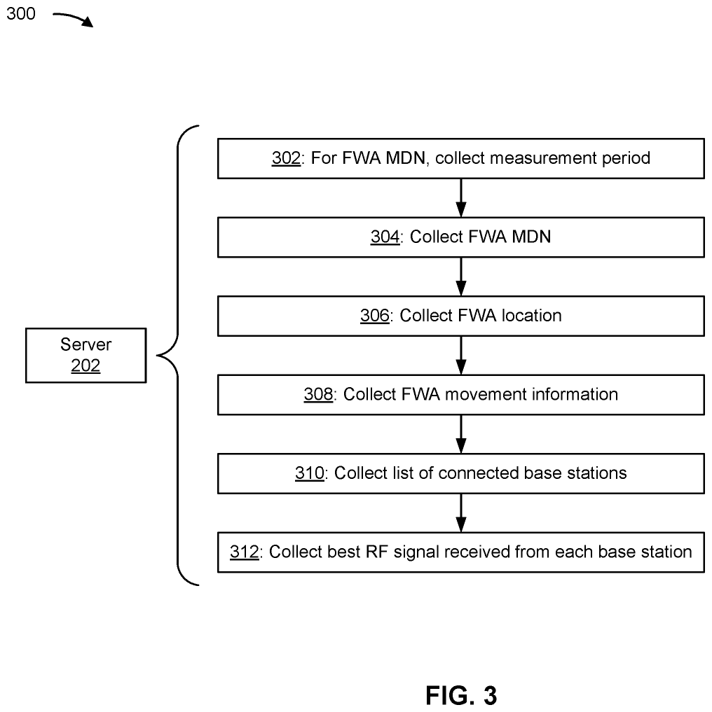

In some implementations, the server 202 may collect information associated with an FWA MDN, where the information may be associated with a measurement period, the FWA MDN, an FWA location, FWA movement within the measurement period, a list of connected network nodes and frequency bands, and/or a best RF signal received from each network node and each frequency band. An example of this flow is shown in FIG. 3.

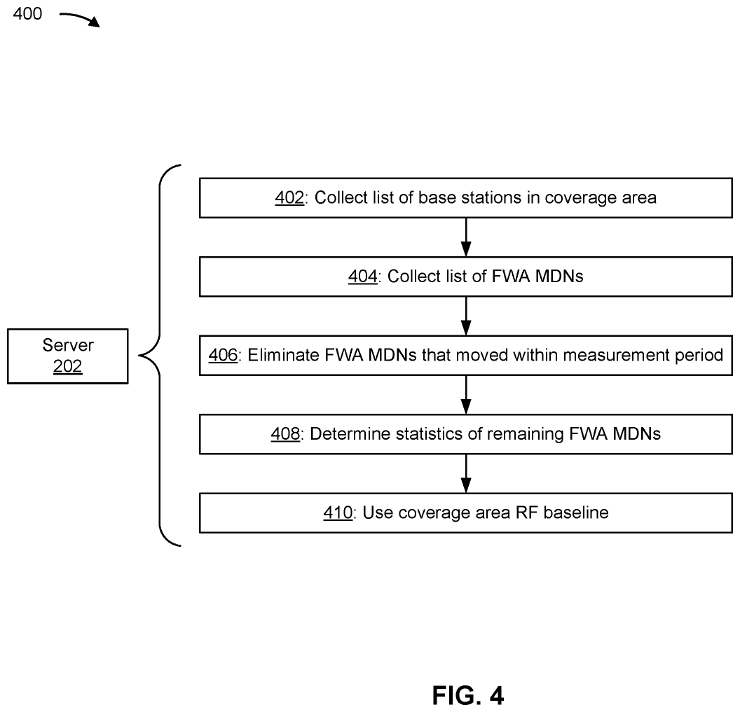

In some implementations, the server 202 may collect, for the coverage area and a frequency band in the measurement period, a list of network nodes that cover the coverage area. The server 202 may collect a list of FWA MDNs associated with reported frequency measurements of the frequency band. The server 202 may eliminate FWA MDNs associated with movement during the measurement period. The server 202 may determine combined statistics of remaining FWA MDNs, where the combined statistics may be based on a number of FWA MDNs, minimum signal measurements, and/or median signal measurements. The server 202 may provide the output based on the combined statistics. The output may be associated with an RF safety margin for adding more FWA MDNs to the coverage area without affecting a mobile MDN performance, a number of FWA MDNs that are able to be added to the coverage area based on an addition or deletion of FWA MDNs of historical periods, and/or a safety margin to handle mobile MDNs. An example of this flow is shown in FIG. 4.

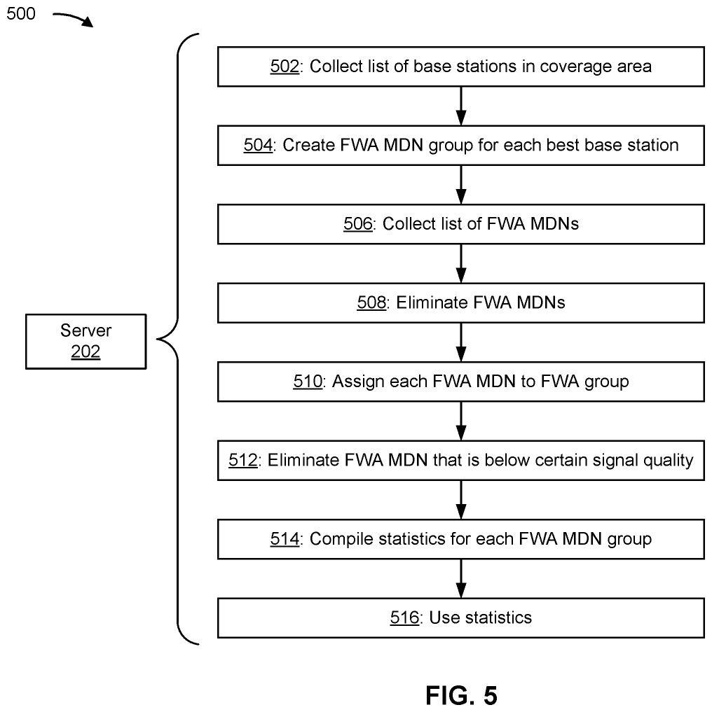

In some implementations, the server 202 may collect, for the coverage area and a frequency band in the measurement period, a list of network nodes that cover the coverage area. The server 202 may create an FWA MDN for each network node in the list of network nodes. The server 202 may collect a list of FWA MDNs associated with reported frequency measurements of the frequency band. The server 202 may eliminate FWA MDNs associated with movement during the measurement period. The server 202 may assign remaining FWA MDNs to one or more FWA MDN groups based on signal strengths for given network nodes. The server 202 may eliminate any FWA MDN that does not satisfy a certain signal quality for each FWA MDN group. The server 202 may compile statistics of each FWA MDN group, where each FWA MDN group may be associated with a signal from a given network node, and the signal may be associated with a number of FWA MDNs, minimum signal measurements, and/or median signal measurements. The server 202 may provide the output based on the statistics. The output may indicate that measurements from each FWA MDN group have changed from a previous measurement period, and based on a comparison of a change and which FWA MDN group is associated with detecting the change, the output may further indicate an inferred timing and source location of the change. An example of this flow is shown in FIG. 5.

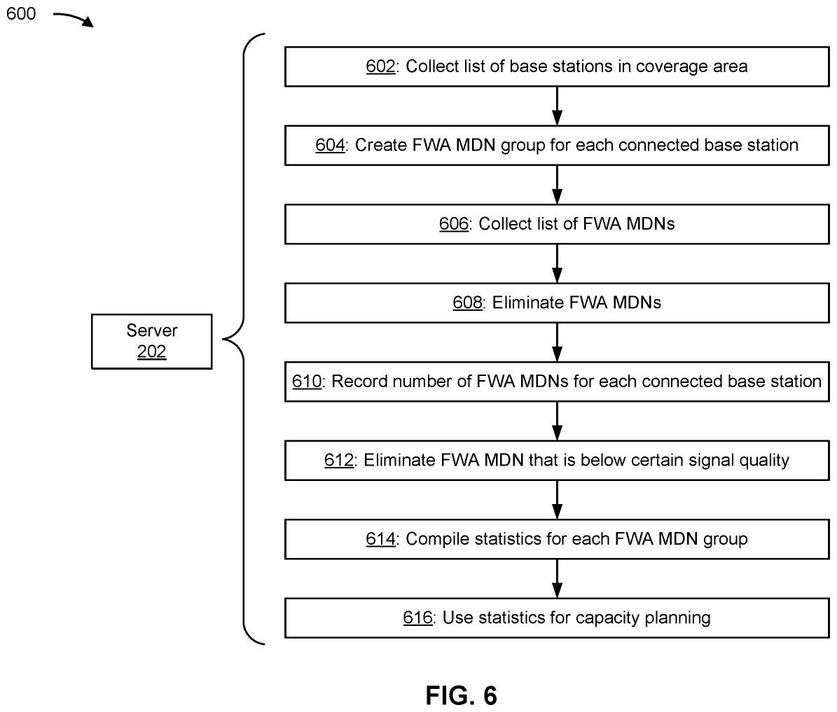

In some implementations, the server 202 may collect, for the coverage area and a frequency band in the measurement period, a list of network nodes that cover the coverage area. The server 202 may create an FWA MDN for each network node in the list of network nodes. The server 202 may collect a list of FWA MDNs that are connected to the network node at the frequency band. The server 202 may eliminate FWA MDNs associated with movement during the measurement period. The server 202 may record a number of FWA MDNs for each network node. The server 202 may assign FWA MDNs to one or more FWA MDN groups based on signal strengths for given network nodes. The server 202 may eliminate any FWA MDN that does not satisfy a certain signal quality for each FWA MDN group. The server 202 may compile statistics of each FWA MDN group based on signals from the network node connected at the frequency band, where each FWA MDN group may be associated with a number of FWA MDNs, minimum signal measurements, and/or median signal measurements. The server 202 may provide an output associated with capacity planning based on the statistics. The output may indicate whether a measurement has changed from a previous measurement period, whether a number of connected FWA MDNs has changed from the previous measurement period, and/or whether more FWA MDNs are able to be added to the network node based on a comparison of an RF baseline service level agreement (SLA) versus a number of connected FWA MDNs. An example of this flow is shown in FIG. 6.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

FIG. 3 is a diagram of an example 300 associated with an FWA RF baseline algorithm.

As shown by reference number 302, for each FWA mobile directory number (MDN), the server 202 may collect attributes of a measurement period, which may include a start time and/or an end time (e.g., one week or more). As shown by reference number 304, the server 202 may collect an indication of an FWA MDN. As shown by reference number 306, the server 202 may collect an indication of an FWA location. As shown by reference number 308, the server 202 may collect an indication of whether an FWA device moved within a time period (e.g., yes or no). As shown by reference number 310, the server 202 may collect a list of connected base stations and frequency bands. As shown by reference number 312, the server 202 may collect an indication of a best RF signal received from each base station and each frequency band. For example, for a certain frequency, and for each of a first base station to an m-th base station, the server 202 may collect an RSRP measurement, an RSRQ measurement, a CQI measurement, an SINR measurement in an uplink direction, and/or an SINR measurement in a downlink direction.

As indicated above, FIG. 3 is provided as an example. Other examples may differ from what is described with regard to FIG. 3.

FIG. 4 is a diagram of an example 400 associated with a coverage area RF baseline (no grouping) algorithm.

As shown by reference number 402, for a given coverage area for a frequency band (e.g., n77) in a measurement period, the server 202 may collect a list of base stations that cover that coverage area. As shown by reference number 404, the server 202 may collect a list of FWA MDNs that are associated with reported frequency measurements of the specific band (e.g., n77). As shown by reference number 406, the server 202 may eliminate FWA MDNs associated with movement during the measurement period. As shown by reference number 408, the server 202 may determine combined statistics of remaining FWA MDNs, which may include a number of FWA MDNs and/or a minimum and median SINR, RSRP, RSRQ, and CQI. As shown by reference number 410, the server 202 may use a coverage area RF baseline accordingly. For example, the server 202 may determine whether an RF baseline has sufficient RF safety margin to add more FWA MDNs without impacting a mobile MDN's performance. As another example, by comparing the addition or deletion of FWA MDNs of historical periods, the server 202 may determine a number of FWA MDNs that can be added to the coverage area. As yet another example, the server 202 may determine a safety margin to handle mobile MDNs.

In some implementations, the server 202 may identify a change in serving access point name (APN) and/or a change in serving physical cell identifier (PCI), where an output may be based on the change in serving APN and/or the change in serving PCI. In other words, in addition to RSRP, RSRQ, CQI, and SINR (e.g., uplink SINR), a change in the serving APN may be used. The change in serving APN may be reported in raw device data, and may indicate a change that can directly impact user experience. Further, the change in serving PCI (per technology and/or per band) may be used, especially for FWA groups that are on higher floors in dense urban areas, which may determine a change in a permanent part of an RF environment.

As indicated above, FIG. 4 is provided as an example. Other examples may differ from what is described with regard to FIG. 4.

FIG. 5 is a diagram of an example 500 associated with an FWA device group by best base station algorithm.

As shown by reference number 502, for a given coverage area for a frequency band (e.g., n77) in a measurement period, the server 202 may collect a list of base stations that cover the coverage area (e.g., base station #1 to #n). For example, four base stations may correspond to four groups. As shown by reference number 504, the server 202 may create an FWA MDN group for each best base station from the list of base stations. Each best base station may be a base station associated with higher signal measurements as compared to other base stations on the list of base stations. As shown by reference number 506, the server 202 may collect a list of FWA MDNs that are associated with reported frequency measurements of the specific band (e.g., n77). As shown by reference number 508, the server 202 may eliminate FWA MDNs associated with movement during the measurement period. As shown by reference number 510, for remaining FWA MDNs, the server 202 may assign each FWA MDN to an FWA group based on the base station associated with the best signals. As shown by reference number 512, for each FWA MDN group, the server 202 may eliminate any FWA MDN that has a signal quality below a threshold signal quality. As shown by reference number 514, the server 202 may compile statistics of each FWA MDN group. The statistics may include a signal from base station #1,which may include a number of FWA MDNs and/or a minimum and median SINR, RSRP, RSRQ, and CQI. The statistics may include a signal from base station #n. An FWA device in a first group may detect signals from other base stations as well. As shown by reference number 516, the server 202 may use the statistics accordingly. For example, the server 202 may determine whether the measurement from each other group substantially changes from a previous measurement period (e.g., whether the change is above a certain threshold). As another example, when the change is substantial, the server 202 may compare the changes and which FWA group detected the changes, which may allow the server 202 to infer the timing and source location.

As indicated above, FIG. 5 is provided as an example. Other examples may differ from what is described with regard to FIG. 5.

FIG. 6 is a diagram of an example 600 associated with an FWA device group by connected base station algorithm.

As shown by reference number 602, for a given coverage area for a frequency band (e.g., n77) in a measurement period, the server 202 may collect a list of base stations that cover that coverage area (e.g., base station #1 to #n). For example, four base stations may correspond to four groups. As shown by reference number 604, the server 202 may create an FWA MDN group for each connected base station. As shown by reference number 606, the server 202 may collect a list of FWA MDNs that are connected to the base station at the specific band (e.g., n77). As shown by reference number 608, the server 202 may eliminate FWA MDNs associated with movement during the measurement period. As shown by reference number 610, the server 202 may record a number of FWA MDNs for each connected base station. As shown by reference number 612, for each FWA MDN group, the server 202 may eliminate any FWA MDN that is below a certain signal quality. As shown by reference number 614, the server 202 may compile statistics of each FWA MDN group based on signals from the connected base station. The statistics may include a number of FWA MDNs and/or a minimum and median SINR, RSRP, RSRQ, and CQI. As shown by reference number 616, the server 202 may use the statistics for capacity planning. For example, the server 202 may determine whether the measurement has substantially changed from a previous measurement period (e.g., whether the change is above a certain threshold). As another example, the server 202 may determine whether a number of connected FWA MDNs has changed from a previous measurement. As yet another example, by comparing an RF baseline SLA versus a number of connected FWA MDNs, the server 202 may determine whether more FWA MDNs can be added to the connected base station.

In some implementations, the server 202 may track a baseline RF environment from one measurement period to a next measurement period. The server 202 may detect changes in the baseline RF environment based on the tracking. In other words, by tracking the baseline RF environment from one measurement period to the next, the server 202 may be able to determine when changes occur. Further, depending on whether the baseline RF environment had changed in the coverage area, the server 202 may rule in or rule out the changes in the baseline RF environment as the source when troubleshooting a UE or FWA device in the coverage area.

As indicated above, FIG. 6 is provided as an example. Other examples may differ from what is described with regard to FIG. 6.

As an example, four towers may provide network coverage to a particular area over one or more spectra, such as the C-band spectrum. The FWA devices may be divided into 4 groups based on which towers each device determines to have the best signal. The FWA devices in group A may have excellent signal from tower A as compared to the other towers. An FWA device in group A may detect the C-band signal at a medium level from Tower D and Tower B. Signal thresholds (e.g., whether a signal is considered excellent or medium) may be configurable. At each measurement period, FWA devices in group A may compile the aggregate signal (RSRP, RSRQ, and SNR) statistics (minimum, maximum, and median) of C-band signals that are received from Tower A, B, C, and D. FWA devices in group A that have not physically moved from a previous measurement period may help in identifying signal changes from Towers A, B, C, and D. When the changes are significant (e.g., above a threshold), the changes for signals are considered significant and one or more actions may be performed thereafter. This process may be repeated for each frequency band transmitted by Towers A, B, C and D.

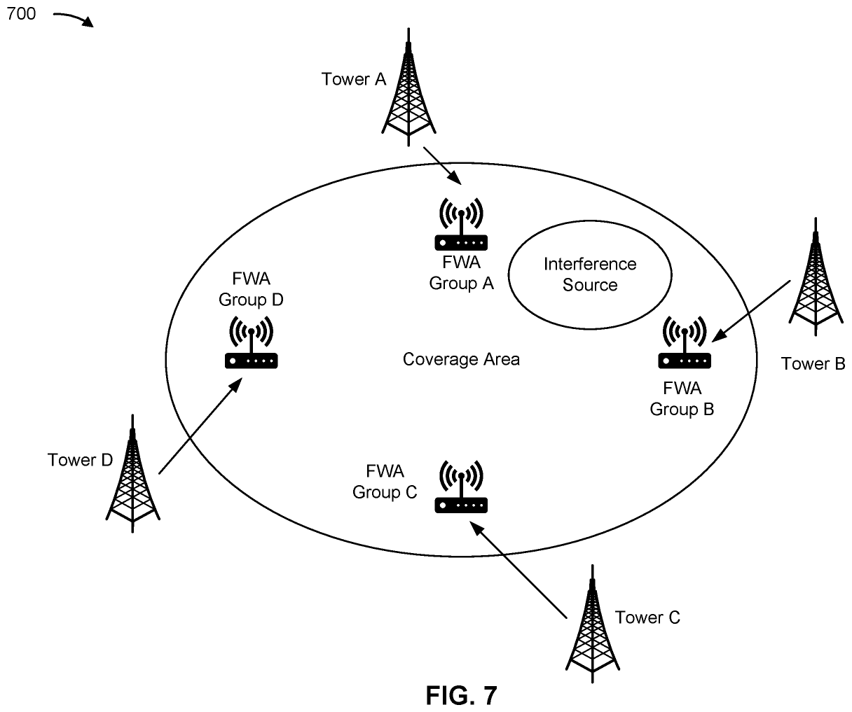

FIG. 7 is a diagram of an example 700 associated with interference.

As shown in FIG. 7, a server may determine that an FWA group A detected SNR from tower B has dropped. The server may determine that an FWA group B detected SNR from tower A has dropped. The server may determine that FWA group C and FWA group D has not detected any changes. Thus, the server may determine that an interference source must be between tower B and group A plus tower A to group B.

As indicated above, FIG. 7 is provided as an example. Other examples may differ from what is described with regard to FIG. 7.

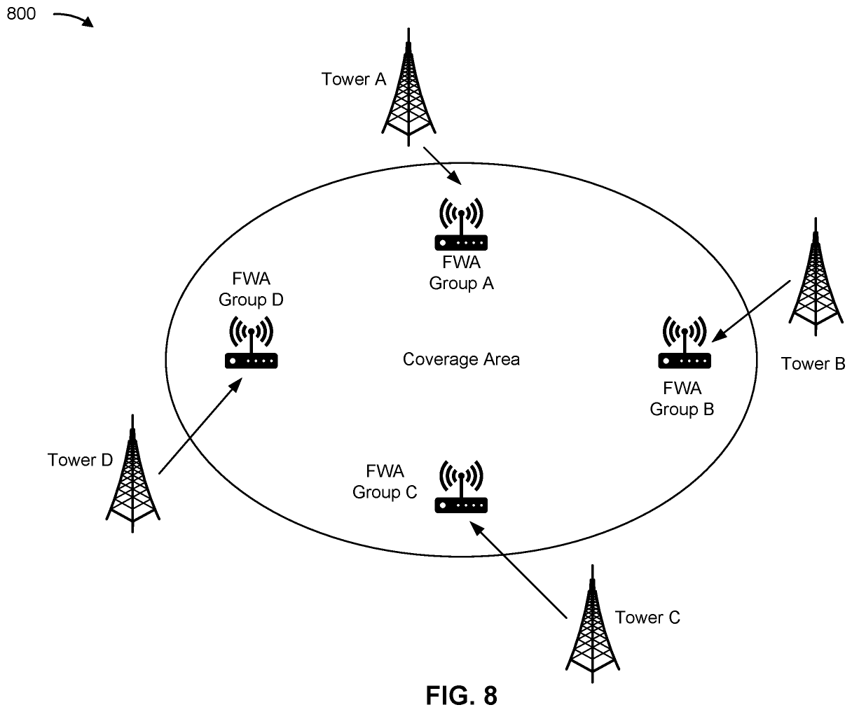

FIG. 8 is a diagram of an example 800 associated with transmit power.

As shown in FIG. 8, a server may determine that a signal measurement from tower B has dropped based on reported signal measurements from FWA groups. In this case, the server may detect that a transmit power associated with tower B may be below a threshold. The server may not detect that signals from other towers have dropped in quality, based on the reported signal measurements from the FWA groups, which may imply that transmit powers associated with the other towers satisfy the threshold.

As indicated above, FIG. 8 is provided as an example. Other examples may differ from what is described with regard to FIG. 8.

In some implementations, using an FWA device as an RF detector may be useful for FWA capacity planning (grouped by connection). Using the number of FWA devices connected to a base station for capacity planning may not account for a baseline RF environment of existing FWA devices and the coverage area. The capacity of the base station to support additional FWA users may be dependent on an SINR of the FWA devices, where the SINR may be dependent on an actual spatial distribution of the FWA devices (close or further away). Each additional or removal of the FWA devices in the coverage area may impact the SINR or one or more existing FWA devices. Further, using the signal measurement of the FWA devices may not account for interference due to UEs.

In some implementations, transient interference may be eliminated by using the best signal measurement over a relatively long period of time (e.g., one week). By measuring the best signal measurement of the existing FWA devices connected to a base station, the safety margin/capacity of the base station to support more FWA users may be measured. Since the FWA device may not move, each addition and removal of FWA devices may affect a permanent part of an RF measurement. By tracking changes to a baseline RF measurement, an amount of FWA devices that can be supported by the base station may be predicted.

In some implementations, a server (e.g., server 202) may determine whether a network slice SLA is capable of being satisfied based on the baseline RF environment. In other words, using an FWA device as an RF detector may be useful for a 5G slice SLA (grouped by connection). The baseline RF measurement may be used to deliver a certain level of SLA for 5G. For example, when an SINR of the baseline RF environment does not satisfy a threshold, a 5G slice SLA cannot be satisfied. The 5G slice SLA may account for the baseline RF environment, and FWA device measurements may be used with filtering to separate a mobile MDN impact versus the baseline RF environment.

In some implementations, the server may identify permanent signal disruption based on the baseline RF environment. The server may provide an indication of locations with permanent coverage disruptions for network planning and operations. The server may provide an indication of the locations for new site builds. The server may provide advertising to households in locations without permanent coverage disruptors.

In some implementations, using an FWA device as an RF detector may serve to proactively identify new permanent signal disruption for customer care troubleshooting experiences. Information regarding locations with new serious permanent coverage disruptions may be fed back to a network planning and operations platform. Information regarding the locations may be fed back to RF planning/engineering to plan new site builds. Anonymized coverage data may be made available to third parties. Further, such information may be used to enhance root metrics analysis and to guide advertising campaigns to priority target households in locations without permanent coverage disruptors.

In some implementations, using an FWA device as an RF detector may reduce time spent on field visits doing manual site-to-site correlation and may reduce time to identify and fix network issues. Configuration changes, site modifications, and/or new site builds may be prioritized based on FWA groups. Further, band specific configuration discrepancies may be detected, especially when a new carrier or site was added (e.g., a new site comes on air with incorrect transmission mode 2TX/4TX/8TX or carrier aggregation settings).

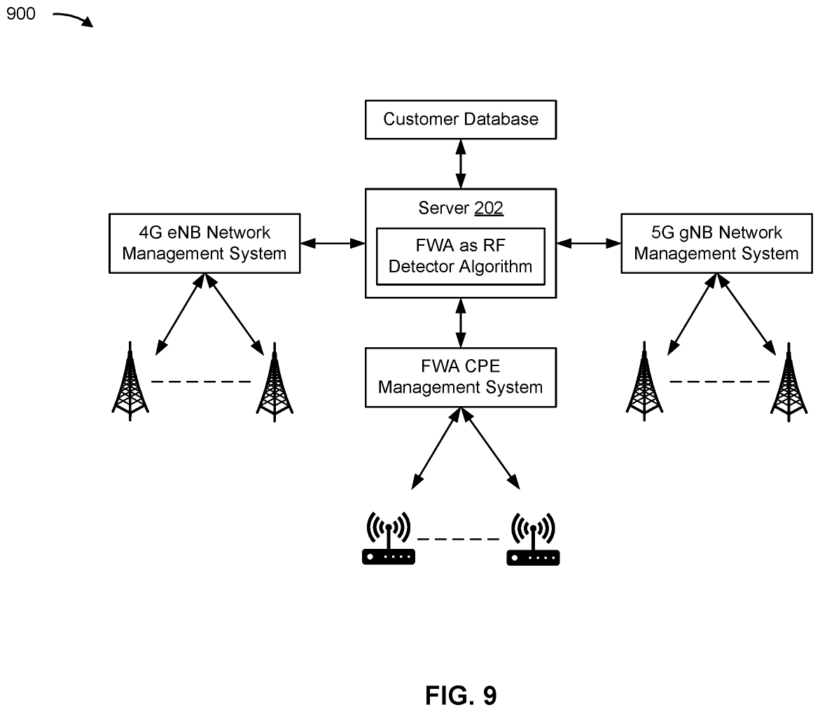

FIG. 9 is a diagram of an example 900 associated with an FWA as RF detector algorithm.

As shown in FIG. 9, a server 202 may run the FWA as an RF detector algorithm. The server 202 may communicate with a customer database, a 4G eNB network management system, an FWA customer premise equipment (CPE) management system, and/or a 5G gNB network management system. The 4G eNB network management system may collect information regarding sectors, MDNs, and/or signal strengths of each MDN, and report such information to the server 202. The FWA CPE management system may collect information regarding signal strengths of MDNs with each eNB/gNB, and report such information to the server 202. The 5G gNB network management system may collect information regarding sectors, MDNs, and/or signal strengths of each MDN, and report such information to the server 202. The server 202, using information received from the 4G eNB network management system, the FWA CPE management system, and/or the 5G gNB network management system, may determine a baseline RF measurement, compare changes in the baseline RF measurement to detect RF coverage problems, use grouping techniques to detect source locations and capacity planning, and so on.

As indicated above, FIG. 9 is provided as an example. Other examples may differ from what is described with regard to FIG. 9.

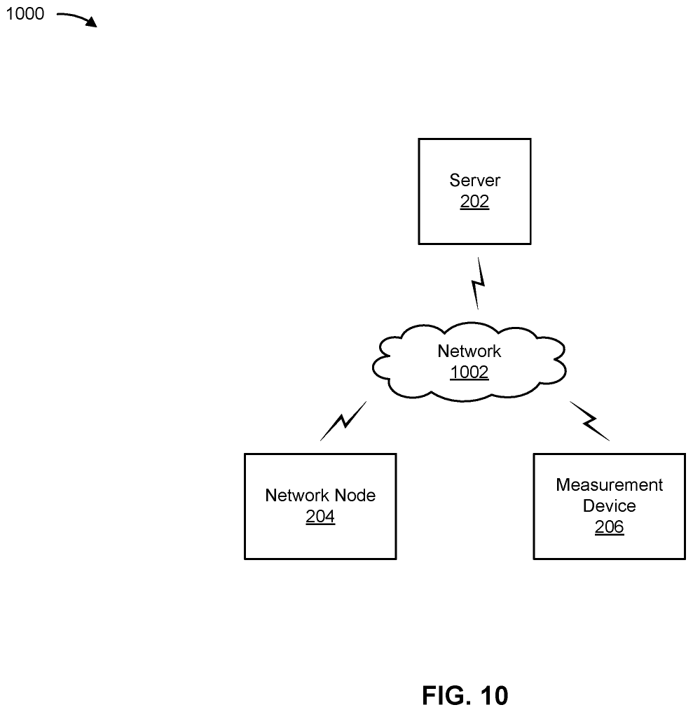

FIG. 10 is a diagram of an example environment 1000 in which systems and/or methods described herein may be implemented. As shown in FIG. 10, environment 1000 may include a server 202, a network node 204, a measurement device 206, and a network 1002. Devices of environment 1000 may interconnect via wired connections, wireless connections, or a combination of wired and wireless connections.

The server 202 may include one or more devices capable of receiving, generating, storing, processing, providing, and/or routing information associated with deriving baseline RF measurements of coverage areas, as described elsewhere herein. The server 202 may include a communication device and/or a computing device. For example, the server 202 may include a server, such as an application server, a client server, a web server, a database server, a host server, a proxy server, a virtual server (e.g., executing on computing hardware), or a server in a cloud computing system. In some implementations, the server 202 may include computing hardware used in a cloud computing environment.

The network node 204 may include one or more devices capable of receiving, processing, storing, routing, and/or providing information associated with deriving baseline RF measurements of coverage areas, as described elsewhere herein. The network node 204 may be an aggregated network node, meaning that the aggregated network node is configured to utilize a radio protocol stack that is physically or logically integrated within a single radio access network (RAN) node (e.g., within a single device or unit). The network node 204 may be a disaggregated network node (sometimes referred to as a disaggregated base station), meaning that the network node 204 is configured to utilize a protocol stack that is physically or logically distributed among two or more nodes (such as one or more central units (CUs), one or more distributed units (DUs), or one or more radio units (RUs)). The network node 204 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, and/or a RAN node.

The measurement device 206 may include one or more devices capable of receiving, generating, storing, processing, and/or providing information associated with deriving baseline RF measurements of coverage areas, as described elsewhere herein. The measurement device 206 may include a communication device and/or a computing device. For example, the measurement device 206 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network 1002 may include one or more wired and/or wireless networks. For example, the network 1002 may include a cellular network (e.g., a Fifth Generation (5G) network, a Fourth Generation (4G) network, a Long Term Evolution (LTE) network, a Third Generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 1002 may enable communication among the one or more devices of environment 1000.

The number and arrangement of devices and networks shown in FIG. 10 are provided as an example. In practice, there may be additional devices and/or networks, fewer devices and/or networks, different devices and/or networks, or differently arranged devices and/or networks than those shown in FIG. 10. Furthermore, two or more devices shown in FIG. 10 may be implemented within a single device, or a single device shown in FIG. 10 may be implemented as multiple, distributed devices. Additionally, or alternatively, a set of devices (e.g., one or more devices) of environment 1000 may perform one or more functions described as being performed by another set of devices of environment 1000.

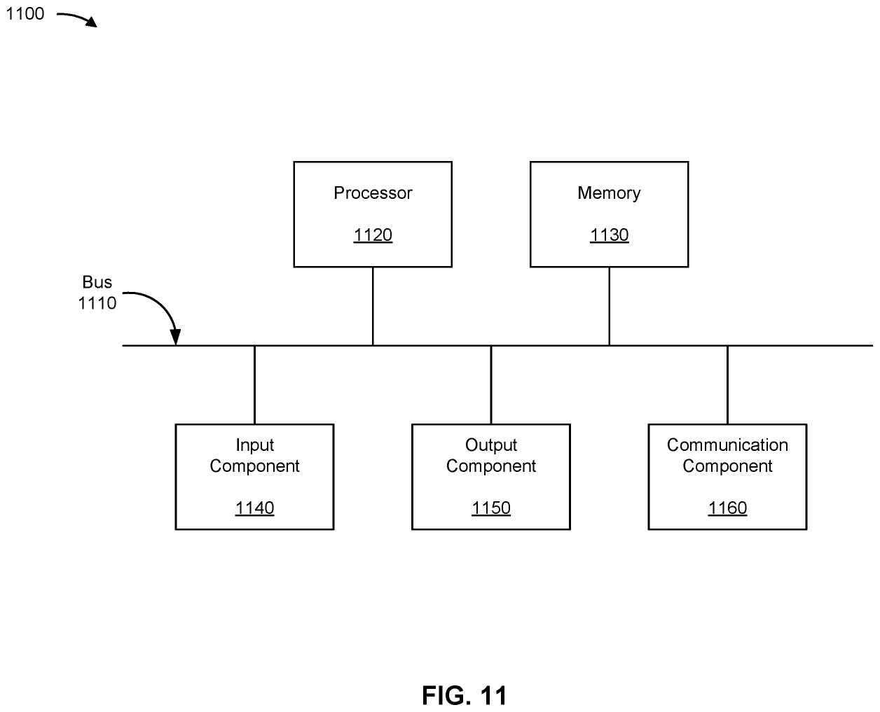

FIG. 11 is a diagram of example components of a device 1100 associated with a unified API proxy that supports multiple vendors. The device 1100 may correspond to a server (e.g., server 202). In some implementations, the server may include one or more devices 1100 and/or one or more components of the device 1100. As shown in FIG. 11, the device 1100 may include a bus 1110, a processor 1120, a memory 1130, an input component 1140, an output component 1150, and/or a communication component 1160.

The bus 1110 may include one or more components that enable wired and/or wireless communication among the components of the device 1100. The bus 1110 may couple together two or more components of FIG. 11, such as via operative coupling, communicative coupling, electronic coupling, and/or electric coupling. For example, the bus 1110 may include an electrical connection (e.g., a wire, a trace, and/or a lead) and/or a wireless bus. The processor 1120 may include a central processing unit, a graphics processing unit, a microprocessor, a controller, a microcontroller, a digital signal processor, a field-programmable gate array, an application-specific integrated circuit, and/or another type of processing component. The processor 1120 may be implemented in hardware, firmware, or a combination of hardware and software. In some implementations, the processor 1120 may include one or more processors capable of being programmed to perform one or more operations or processes described elsewhere herein.

The memory 1130 may include volatile and/or nonvolatile memory. For example, the memory 1130 may include random access memory (RAM), read only memory (ROM), a hard disk drive, and/or another type of memory (e.g., a flash memory, a magnetic memory, and/or an optical memory). The memory 1130 may include internal memory (e.g., RAM, ROM, or a hard disk drive) and/or removable memory (e.g., removable via a universal serial bus connection). The memory 1130 may be a non-transitory computer-readable medium. The memory 1130 may store information, one or more instructions, and/or software (e.g., one or more software applications) related to the operation of the device 1100. In some implementations, the memory 1130 may include one or more memories that are coupled (e.g., communicatively coupled) to one or more processors (e.g., processor 1120), such as via the bus 1110. Communicative coupling between a processor 1120 and a memory 1130 may enable the processor 1120 to read and/or process information stored in the memory 1130 and/or to store information in the memory 1130.

The input component 1140 may enable the device 1100 to receive input, such as user input and/or sensed input. For example, the input component 1140 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 1150 may enable the device 1100 to provide output, such as via a display, a speaker, and/or a light-emitting diode. The communication component 1160 may enable the device 1100 to communicate with other devices via a wired connection and/or a wireless connection. For example, the communication component 1160 may include a receiver, a transmitter, a transceiver, a modem, a network interface card, and/or an antenna.

The device 1100 may perform one or more operations or processes described herein. For example, a non-transitory computer-readable medium (e.g., memory 1130) may store a set of instructions (e.g., one or more instructions or code) for execution by the processor 1120. The processor 1120 may execute the set of instructions to perform one or more operations or processes described herein. In some implementations, execution of the set of instructions, by one or more processors 1120, causes the one or more processors 1120 and/or the device 1100 to perform one or more operations or processes described herein. In some implementations, hardwired circuitry may be used instead of or in combination with the instructions to perform one or more operations or processes described herein. Additionally, or alternatively, the processor 1120 may be configured to perform one or more operations or processes described herein. Thus, implementations described herein are not limited to any specific combination of hardware circuitry and software.

The number and arrangement of components shown in FIG. 11 are provided as an example. The device 1100 may include additional components, fewer components, different components, or differently arranged components than those shown in FIG. 11. Additionally, or alternatively, a set of components (e.g., one or more components) of the device 1100 may perform one or more functions described as being performed by another set of components of the device 1100.

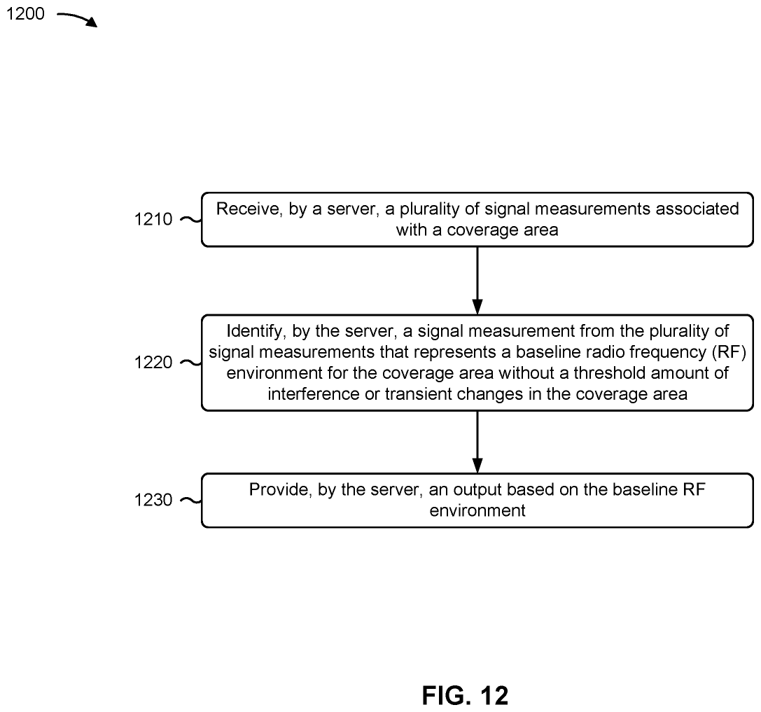

FIG. 12 is a flowchart of an example process 1200 associated with deriving baseline RF measurements of coverage areas. In some implementations, one or more process blocks of FIG. 12 may be performed by a server (e.g., server 202). Additionally, or alternatively, one or more process blocks of FIG. 12 may be performed by one or more components of device 1100, such as processor 1120, memory 1130, input component 1140, output component 1150, and/or communication component 1160.

As shown in FIG. 12, process 1200 may include receiving, by the server, a plurality of signal measurements associated with a coverage area (block 1210). The plurality of signal measurements may be collected over a measurement period by a device (e.g., a measurement device) within the coverage area while the device is associated with a fixed location. The plurality of signal measurements may include RSRP measurements, RSRQ measurements, CQI measurements, and/or SINR measurements. The measurement period may be an extended period of time, such as one week or longer, during which the device may be stationary. The plurality of measurements may be received from the device and/or a network node, where the device may be an FWA device.

As shown in FIG. 12, process 1200 may include identifying, by the server, a signal measurement from the plurality of signal measurements (block 1220). The signal measurement may represent a baseline RF environment for the coverage area without the presence of a threshold amount of interference and/or transient changes in the coverage area. The signal measurement may characterize a fundamental RF environment of the coverage area, and may represent an RF environment that is not affected or minimally affected by interference from UEs in the coverage area and/or transient changes in the coverage area. The signal measurement may correspond to a time during the measurement period at which measurement devices are not subject to interference from the UEs or temporary disturbance, and such time may be referred to as “quiet time”.

As shown in FIG. 12, process 1200 may include providing, by the server, an output based on the baseline RF environment (block 1230). For example, the output may be associated with an RF safety margin for adding additional UEs to the coverage area. The output may be an indication of whether measurements have changed from a previous measurement period. The output may be an indication of whether a number of connected UEs have changed from the previous measurement period. The output may be associated with inferred timing and source locations of changes in the coverage area. The output may be used to perform one or more actions, e.g. actions associated with capacity planning. One or more network nodes associated with the coverage area may adjust settings based on the output, which may include settings for handling an increased number of UEs in the coverage area.

Although FIG. 12 shows example blocks of process 1200, in some implementations, process 1200 may include additional blocks, fewer blocks, different blocks, or differently arranged blocks than those depicted in FIG. 12. Additionally, or alternatively, two or more of the blocks of process 1200 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a server, a plurality of signal measurements associated with a coverage area, wherein the plurality of signal measurements are collected over a measurement period by a device within the coverage area while the device is associated with a fixed location;
identifying, by the server, a signal measurement from the plurality of signal measurements, wherein the signal measurement represents a baseline radio frequency (RF) environment for the coverage area without a threshold amount of interference or transient changes in the coverage area; and
providing, by the server, an output based on the baseline RF environment.

2. The method of claim 1, wherein the plurality of signal measurements include one or more of: reference signal received power (RSRP) measurements, reference signal received quality (RSRQ) measurements, channel quality indicator (CQI) measurements, or signal-to-interference-plus-noise ratio (SINR) measurements.

3. The method of claim 1, wherein the measurement period is one week or longer.

4. The method of claim 1, wherein the plurality of signal measurements are received from one or more of a measurement device or a network node, wherein the measurement device includes a fixed wireless access (FWA) device.

5. The method of claim 1, further comprising:
collecting, by the server, information associated with a fixed wireless access (FWA) mobile directory number (MDN), wherein the information is associated with one or more of: a measurement period, the FWA MDN, an FWA location, FWA movement within the measurement period, a list of connected network nodes and frequency bands, and a best RF signal received from each network node and each frequency band.

6. The method of claim 1, further comprising:
collecting, by the server and for the coverage area and a frequency band in the measurement period, a list of network nodes that cover the coverage area;
collecting, by the server, a list of fixed wireless access (FWA) mobile directory numbers (MDNs) associated with reported frequency measurements of the frequency band;
eliminating, by the server, FWA MDNs associated with movement during the measurement period;
determining, by the server, combined statistics of remaining FWA MDNs, wherein the combined statistics are based on a number of FWA MDNs, minimum signal measurements, and median signal measurements; and
providing, by the server, the output based on the combined statistics, wherein the output is associated with one or more of: an RF safety margin for adding more FWA MDNs to the coverage area without affecting a mobile MDN performance, a number of FWA MDNs that are able to be added to the coverage area based on an addition or deletion of FWA MDNs of historical periods, or a safety margin to handle mobile MDNs.

7. The method of claim 1, further comprising:
collecting, by the server and for the coverage area and a frequency band in the measurement period, a list of network nodes that cover the coverage area;
creating, by the server, a fixed wireless access (FWA) mobile directory number (MDN) for each network node in the list of network nodes;
collecting, by the server, a list of FWA MDNs associated with reported frequency measurements of the frequency band;
eliminating, by the server, FWA MDNs associated with movement during the measurement period;
assigning, by the server, remaining FWA MDNs to one or more FWA MDN groups based on signal strengths for given network nodes;
eliminating, by the server, any FWA MDN that does not satisfy a certain signal quality for each FWA MDN group;
compiling, by the server, statistics of each FWA MDN group, wherein each FWA MDN group is associated with a signal from a given network node, and the signal is associated with a number of FWA MDNs, minimum signal measurements, and median signal measurements; and
providing, by the server, the output based on the statistics, wherein the output indicates that measurements from each FWA MDN group have changed from a previous measurement period, and based on a comparison of a change and which FWA MDN group is associated with detecting the change, the output further indicates an inferred timing and source location of the change.

8. The method of claim 1, further comprising:
collecting, by the server and for the coverage area and a frequency band in the measurement period, a list of network nodes that cover the coverage area;
creating, by the server, a fixed wireless access (FWA) mobile directory number (MDN) for each network node in the list of network nodes;
collecting, by the server, a list of FWA MDNs that are connected to the network node at the frequency band;
eliminating, by the server, FWA MDNs associated with movement during the measurement period;
recording, by the server, a number of FWA MDNs for each network node;
assigning, by the server, FWA MDNs to one or more FWA MDN groups based on signal strengths for given network nodes;
eliminating, by the server, any FWA MDN that does not satisfy a certain signal quality for each FWA MDN group;
compiling, by the server, statistics of each FWA MDN group based on signals from the network node connected at the frequency band, wherein each FWA MDN group is associated with a number of FWA MDNs and a minimum and median signal measurement; and
providing, by the server, an output associated with capacity planning based on the statistics, wherein the output indicates one or more of: whether a measurement has changed from a previous measurement period, whether a number of connected FWA MDNs has changed from the previous measurement period, or whether more FWA MDNs are able to be added to the network node based on a comparison of an RF baseline service level agreement (SLA) versus a number of connected FWA MDNs.

9. The method of claim 1, further comprising:
tracking, by the server, the baseline RF environment from one measurement period to a next measurement period; and
detecting, by the server, changes in the baseline RF environment based on the tracking.

10. The method of claim 1, further comprising:
determining, by the server, whether a network slice service level agreement (SLA) is capable of being satisfied based on the baseline RF environment.

11. The method of claim 1, further comprising:
identifying, by the server, permanent signal disruption based on the baseline RF environment;
providing, by the server, an indication of locations with permanent coverage disruptions for network planning and operations;
providing, by the server, an indication of the locations for new site builds; or
providing, by the server, advertising to households in locations without permanent coverage disruptors.

12. The method of claim 1, further comprising;
identifying, by the server, one or more of a change in serving access point name (APN) or a change in serving physical cell identifier (PCI), wherein the output is based on one or more of the change in serving APN or the change in serving PCI.

13. A server, comprising:
one or more processors configured to:
receive a plurality of signal measurements associated with a coverage area, wherein the plurality of signal measurements are taken over a period of time by a device within the coverage area while the device is associated with a fixed location;
determine, from the plurality of signal measurements, a baseline radio frequency (RF) environment for the coverage area without a threshold amount of interference or transient changes in the coverage area; and
provide an output based on the baseline RF environment.

14. The server of claim 13, wherein the measurement period is one week or longer.

15. The server of claim 13, wherein the plurality of signal measurements are received from one or more of a fixed wireless access (FWA) device or a network node.

16. The server of claim 13, wherein the one or more processors are further configured to:
track the baseline RF environment from one measurement period to a next measurement period; and
detect changes in the baseline RF environment based on the tracking.

17. A non-transitory computer-readable medium storing a set of instructions, the set of instructions comprising:
one or more instructions that, when executed by one or more processors of a server, cause the server to:
receive a plurality of signal measurements associated with a coverage area, wherein the plurality of signal measurements are taken over a period of time by a device within the coverage area while the device is associated with a fixed location;
determine, from the plurality of signal measurements, a baseline radio frequency (RF) environment for the coverage area without a threshold amount interference or transient changes in the coverage area; and
provide an output based on the baseline RF environment.

18. The non-transitory computer-readable medium of claim 17, wherein the plurality of signal measurements include one or more of: reference signal received power (RSRP) measurements, reference signal received quality (RSRQ) measurements, channel quality indicator (CQI) measurements, or signal-to-interference-plus-noise ratio (SINR) measurements.

19. The non-transitory computer-readable medium of claim 17, wherein the one or more instructions, when executed by the one or more processors, further cause the device to:
determine whether a network slice service level agreement (SLA) is capable of being satisfied based on the baseline RF environment.

20. The non-transitory computer-readable medium of claim 17, wherein the one or more instructions, when executed by the one or more processors, further cause the device to:
identify one or more of a change in serving access point name (APN) or a change in serving physical cell identifier (PCI), wherein the output is based on one or more of the change in serving APN or the change in serving PCI.
